(19) United States
(12) Patent Application Publication
(10) Pub. No.: US 2006/0065685 A1
(43) Pub. Date: Mar. 30, 2006

(54) Overhead access apparatus

(76) Inventor: Carl Fitzsimmons, Sodus Point, NY (US)

Correspondence Address: BASCH & NICKERSON LLP, 1777 PENFIELD ROAD, PENFIELD, NY, 14526, US

(21) Appl. No.: 11/235,828

(22) Filed: Sep. 27, 2005

Related U.S. Application Data
(60) Provisional application No. 60/613,551, filed on Sep. 27, 2004.

(51) Int. Cl. B60R 9/042; B60R 9/00

(52) U.S. Cl. 224/310; 224/321; 414/462

(57) ABSTRACT

The present invention is directed to an apparatus that enables the easy loading and unloading of an overhead load carrier, rack, or similar structure. The apparatus comprises first and second longitudinal rails spaced apart and generally parallel to one another and operatively connected to a surface so as to maintain such spacing. Each rail supports at least one rail car to move thereon, and means for connecting the structure between the rail cars so as to enable the structure to move in a direction parallel to the longitudinal rails and preferably pivot over an edge of the horizontal surface, thereby enabling the structure to be reached by a person located below the surface.

This application claims priority from U.S. Provisional Application No. 60/613,551, for an “APPARATUS TO ENABLE EASY ACCESS TO AN OVERHEAD ASSEMBLY” filed Sep. 27, 2004 by C. Fitzsimmons, which is hereby incorporated by reference in its entirety.

### FIELD OF THE PRESENT INVENTION

This invention relates generally to an apparatus for use in the easy loading and unloading of overhead racks or similar storage and transport structures for holding goods, and more particularly to an apparatus such as a load carrier that is attachable to a vehicle's roof top, a cabinet top or any other overhead horizontal surface that allows a user to position the apparatus in a loading position alongside the vehicle, cabinet or other structure in order to permit the safe and easy loading and unloading of objects while standing on the ground or otherwise therebelow.

### BACKGROUND OF THE PRESENT INVENTION

The use of external load carriers on vehicles has become increasingly common in recent years. The combination of high sales volumes of SUV's, minivans, sport wagons, etc., the prevalence of such vehicles with up to three rows of seats, and a growing recreation and travel industry resulted in the need for, and capability to, transport cargo secured on the roof of a vehicle. Such transport typically uses what is commonly referred to as a load carrier or load center, or what also referred to as a roof-rack or a roof top carrier.

Load carriers, as provided as original equipment from the vehicle manufacturer, or from an automotive aftermarket supplier, are well known and provide effective means of transporting skis, kayaks, camping equipment, etc. on the roof of a vehicle. The constructions of such carriers vary greatly in size and geometry. However, such carriers do not provide an easy means for loading and unloading the cargo stored therein. In particular, the rooftops of large SUV's and minivans are frequently inaccessible to those standing on adjacent ground. People, therefore, commonly engage in unsafe practices such as standing on nearby objects, or climbing on the vehicle, in order to load or unload such carriers.

Similarly, overhead storage racks and/or the placement of containers on the tops of cabinets, refrigerators and other overhead surfaces is common in order to optimize the use of storage space in homes, businesses etc. Like vehicle carriers, these overhead storage devices are generally inaccessible for the average person standing on the floor. Consequently, people engage in the same unsafe practice of standing on nearby objects, such as a chair, in order to load and unload the overhead storage devices.

Hence, there is a need for an apparatus, which permits carriers and other overhead storage devices to be easily reached, loaded, and unloaded by a person of small or average stature when the person is standing upon adjacent ground or floor. Moreover, with respect to vehicle carriers, it is desirable that such an apparatus be easily adapted or retrofitted to any of the diverse existing carriers and installed without the need for specific components or drilling.

### SUMMARY OF THE PRESENT INVENTION

The present invention involves an apparatus to enable the easy loading and unloading of an overhead structure or storage device (e.g., a rack or other load carrier). In accordance with an aspect of the present invention, there is disclosed an apparatus to enable access to an overhead structure, comprising: first and second longitudinal rails, said rails being operatively connected to a surface so as maintain the rails in a spaced apart and generally parallel relationship; at least one rail car supported by and operatively engaged with each of the first and second longitudinal rails; and a connecting assembly operatively connecting the overhead structure and rail cars to enable said connecting assembly to move in a direction parallel to said longitudinal rails and over an edge of the surface, thereby enabling the overhead structure to be reached by a person below the surface.

In accordance with another aspect of the present invention, there is disclosed a vehicle rooftop transport apparatus to enable access to an overhead rack, comprising: first and second longitudinal rails, said rails being operatively connected to the rooftop so as maintain the rails in a spaced apart and generally parallel relationship; at least one rail car supported by and operatively engaged with each of the first and second longitudinal rails; and a connecting assembly operatively connecting the rail cars to enable said connecting assembly to move in a direction parallel to said longitudinal rails and to pivot over an edge of the rooftop so as to be generally adjacent a side of the vehicle, thereby enabling the rack to be reached at a position other than the rooftop.

### BRIEF DESCRIPTION OF THE DRAWINGS

The present invention may take form in various embodiments, including alternative components and arrangements of components, and in various steps and arrangements of steps. The drawings are only for purposes of illustrating a preferred embodiment and are not to be construed as limiting the present invention, wherein:

FIG. 1 is an illustration of an exemplary embodiment of the present invention in association with a rooftop carrier;

FIGS. 2 and 3 are illustrative planar views of the embodiment of FIG. 1, in two different positions;

FIG. 4 is an alternative illustration of the use of the present invention on a horizontal surface such as the top of refrigerator;

FIGS. 5-7 are alternative detailed views of the rail car of FIGS. 1-4;

FIG. 8 is top view of a general embodiment in accordance with aspects of the invention;

FIGS. 9 and 10 are illustrative side views of components of the present invention; and

FIGS. 11 and 12 are exemplary views of the end caps in one embodiment of the present invention and alternative methods of employing the invention with conventional roof-top rack systems.

### DESCRIPTION OF THE PREFERRED EMBODIMENT

The present invention will be described in connection a preferred embodiment, however, it will be understood that there is no intent to limit the invention to the embodiments described. On the contrary, the intent is to cover all alternatives, modifications, and equivalents as may be included within the spirit and broad scope of the invention as defined by the appended claims.

For a general understanding of the present invention, reference is made to the drawings. In the drawings, like reference numerals have been used throughout to designate identical elements. It is also noted that the various drawings illustrating the present invention are not to scale and that certain regions may have been purposely drawn disproportionately so that the features and concepts of the present invention could be properly illustrated.

As noted above, the present invention is directed to an apparatus to enable the easy loading and unloading of an overhead storage rack or other structure. The present invention can be utilized for a variety of overhead storage devices including a vehicle carrier or a cabinet rack. The present invention will be described in detail with respect to an apparatus for use with a vehicle carrier, although the invention is not intended to be limited by such an application. As will be described in more detail below, the rack structure is slidably coupled to the roof of the vehicle, using conventional rails found on many vehicles, while permitting it to slide outward where it may be lowered to a loading position, and subsequently returned to the top of the vehicle for storage and transportation.

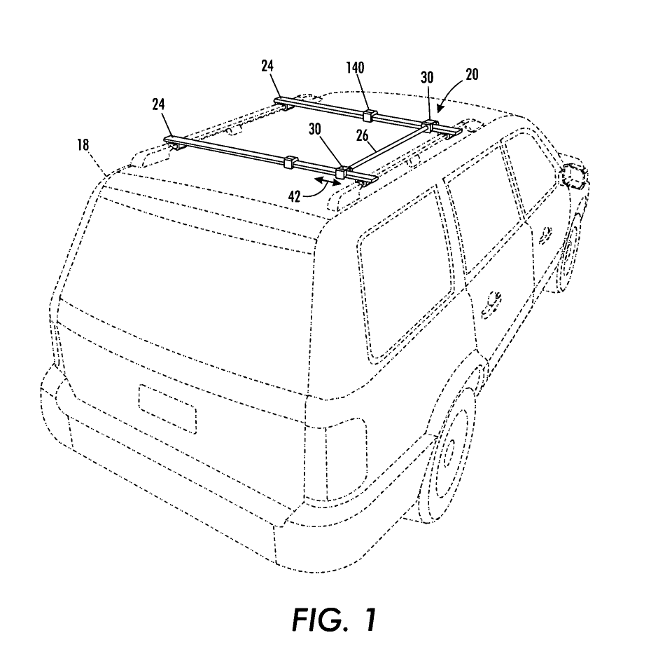

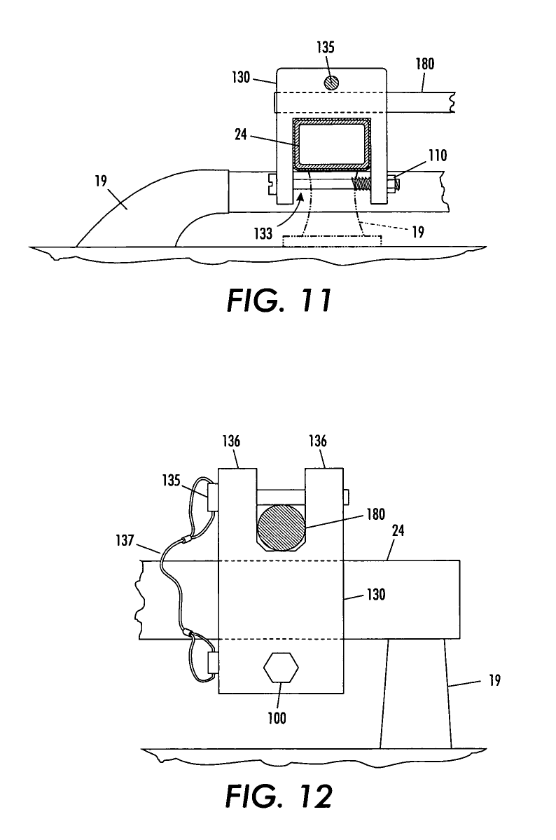

Referring to FIG. 1, there is depicted an apparatus to enable access to an overhead structure such as a vehicle-top or rooftop rack. More specifically, apparatus 20 includes first and second longitudinal rails 24, said rails being operatively connected to the vehicle surface or rooftop 30 so as maintain the rails in a spaced apart and generally parallel relationship. It will be appreciated that vehicle 18 may have existing longitudinal rails 24, which are typically adjustable in the spacing therebetween and are slidable within channels mounted to the vehicle roof or side rails as depicted in the figure. Such longitudinal rails may also be part of an after-market product. One aspect of the present invention is a design intended to work with a range of existing original equipment roof mounting systems and after-market products, and simply requires that the roof mounting system include or permit the attachment of parallel longitudinal rails 24 above the roof surface. Two alternative roof mounting systems (side rails and standoffs) are intentionally depicted in FIGS. 11 and 12, both are labeled with reference numeral 19.

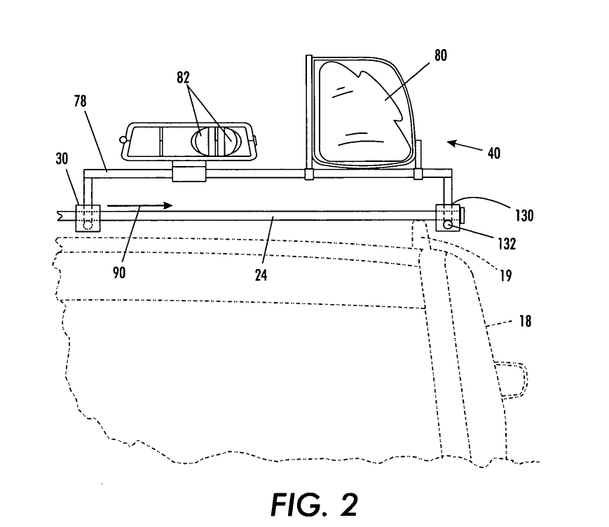

On each rail 24 is mounted at least one rail car 30 (two if separate equipment racks are to be accessed from each side of the vehicle). The rail cars, as will be described in further detail below, are supported by and operatively engaged with each of the longitudinal rails 24. Furthermore, a connecting assembly, for example a rod 26, operatively connects the rail cars 30 and an overhead rack (see rack 40 in FIG. 2) or similar structure. As will be appreciated, the present invention is not limited to the type or nature of rack employed therewith and is intended to accommodate various types of racks or structures. As will be further appreciated, the use of sliding rail cars enable said connecting assembly 26 and the associated structure (see FIG. 2), to move in a direction indicated by arrow 42, parallel to said longitudinal rails. When moved to the outermost position (toward the side of vehicle 18, the rack may be pivoted about the connecting assembly and over an edge of the vehicle rooftop surface, thereby enabling the rack to be reached by a person standing alongside the vehicle.

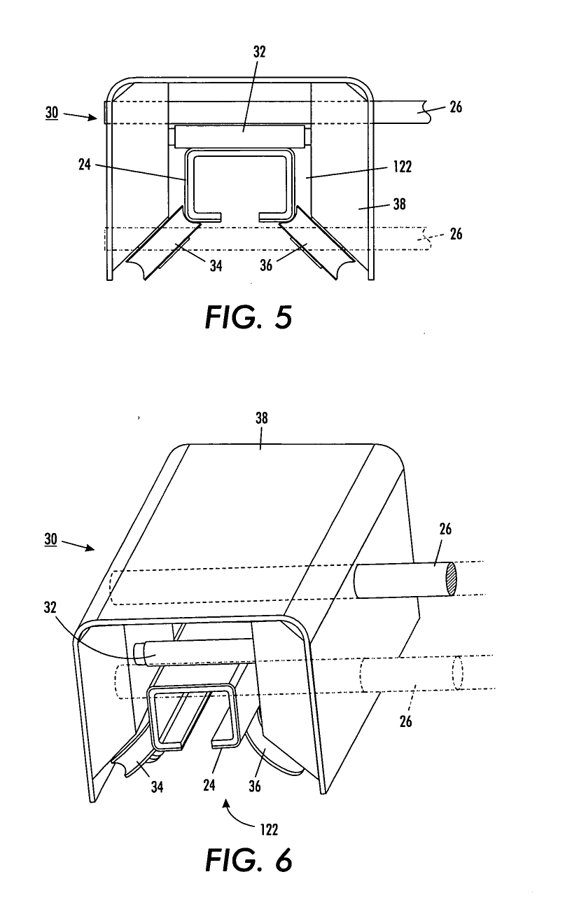

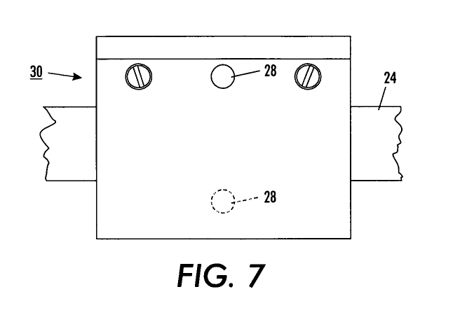

Referring also to FIGS. 5 and 6, the rail cars 30 are of a universal design, in the general shape of a U-shaped block, and include at least two pairs of opposed rollers 32, 33 and 34 for contacting an outer peripheral surface of the longitudinal rail 24 to permit the rail car to move along the longitudinal rail. In other words, the rail cars are designed to fit over and about the rails, while providing clearance between the rail car housing 38 and the rail, and where the roller combinations provide support for the rail car. Housing 38 is preferably a molded polymer component (e.g., polycarbonate) and is intended to withstand environmental exposure (e.g., temperature, sunlight). It will be appreciated that alternative materials may be employed. As illustrated in FIGS. 5 and 6, at least one opposed roller (32) is a bushing-type roller, and other rollers (e.g., 34 and 36) may be flat or concave along the outer periphery in a longitudinal direction.

In the embodiment depicted there are pairs of rollers 32, 34 and 36, however, in certain embodiments, it may be possible to use fewer rollers. For example, only one bushing-type roller 32, so that five rollers are used for contacting an outer peripheral surface of the longitudinal rail to keep the rail car on a path determined by the longitudinal rail 24. It will also be appreciated that while depicted as a rectangular channel, rail 24 may also take on various cross-sectional shapes including, but not limited to a square, a rectangle, a circle, an ellipse, a hexagon, and a channel as well as combinations of such shapes.

It is further anticipated that, as depicted in FIG. 2, an embodiment of the disclosed apparatus is intended to be usable with conventional rack elements. In such a situation, the rail cars 30 are assembled about the longitudinal rails 24 on vehicle 18. Rails are typically supported at or near the ends thereof by side rail channels and/or stand-offs 19, the configuration of which is somewhat dependent upon the manufacturer's roof-top attachment system. The rollers (FIG. 5) are inserted and affixed and then a connecting assembly 26 is inserted into the rail cars 30. Attached to the connecting assembly is a rack 40 or similar and conventional support structure 78, suitable for supporting and attaching sporting equipment such as skis 82 or kayaks 80, luggage, or other articles that are conventionally carried on the top of vehicles using well-known racks such as those manufactured by Thule, and others. At the outer end of the longitudinal rail, the rack 40 is attached to and supported by an end block or end support cap 130, which may provide a pin or locking mechanism 132.

Another feature of the disclosed design is a universal rail car design such that alternative rollers and mounting locations are provided and where the universal design rail car may be employed with a plurality of rail cross-sections and configurations. For example, depending upon the clearance and the rack or support 78 being used, the connecting assembly 26 may be positioned at an upper or lower position midway in the rail car, as depicted in FIGS. 5 7. In the alternative designs, the rail car housing 38 includes an aperture 28 or through-hole for receiving an end of the connecting assembly. The position of the aperture 28 and connecting assembly 26 is not only a function of the rail car design, but also of the intended rack and vehicle rail configuration. The use of the upper or lower aperture for receiving the connecting assembly in the rail car will permit differing offsets of the attached rack, without increasing the height of the rack above the vehicle top.

It is further contemplated that an end of the connecting assembly is operatively retained in relation to said rail car by a clamping mechanism associated with said rail car. The clamping mechanism may take the form of a split pillow-block, where one-half is molded as part of the rail car and another half is attached to the rail car by bolts/nuts (not shown) so as to clamp the assembly 26, therebetween and affix it to the rail car.

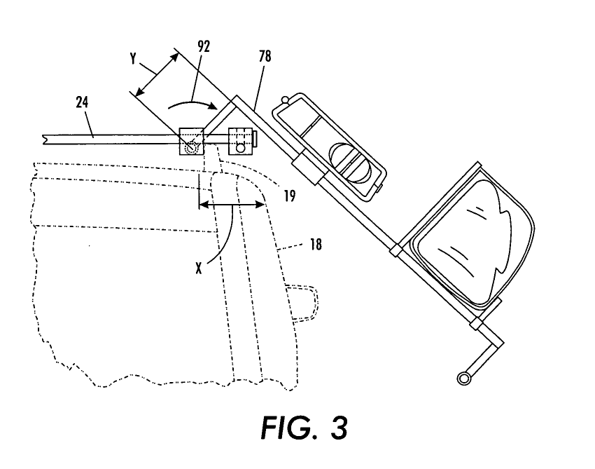

Referring also to FIG. 3, for example, the connecting assembly 26 supports the structure thereon and the rack structure 40 is offset a distance Y from the connecting assembly to allow the rack structure to pivot about the connecting assembly or a hinge thereon when the rail cars are moved toward an outer end of the respective rails as indicated by arrow 90 in FIG. 2. If the distance Y is greater than X (offset between maximum rail car travel and the edge of the vehicle, then the rack will swing out as indicated by arrow 92 and extend along the side of the vehicle 18.

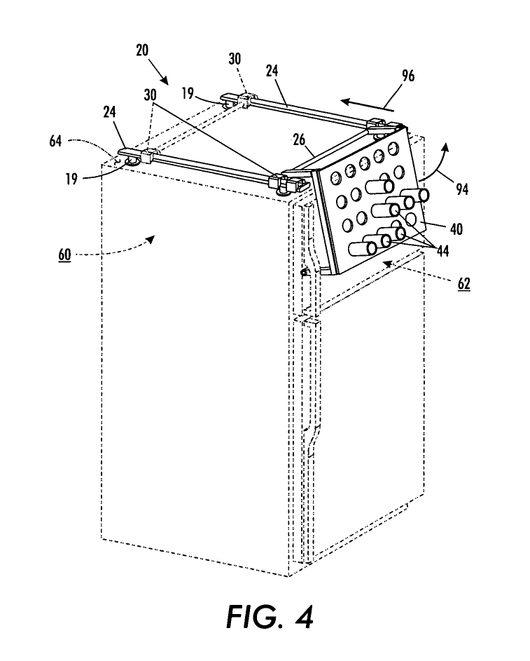

Turning next to FIG. 4, there is depicted an alternative embodiment of the present invention wherein the apparatus is employed to provide easy access to cabinet-top racks and the like, including storage on the top of a refrigerator, as depicted, or other horizontal surfaces. More specifically, the apparatus may be used on cabinet 60, which may be a kitchen cabinet, the top of a refrigerator or other appliance, or similar elevated horizontal surface including a high shelf, and perhaps having a door 62. The invention may also find practical use for individuals with disabilities that may be wheelchair bound, and permit the efficient use of conventional countertop surfaces. On the top of the cabinet, the overhead access apparatus 20 is connected to the horizontal surface 64 by standoffs 19.

Apparatus 20 includes first and second longitudinal rails 24 operatively connected to the surface 64 so as maintain the rails in a spaced apart and generally parallel relationship. On each rail 24 is mounted at least one rail car 30. The rail cars, as described above, are supported by and operatively engaged with each of the longitudinal rails 24. Furthermore, a connecting assembly, for example rod 26, operatively connects the rail cars 30 and the overhead rack 40 or similar structure. As will be appreciated, the present invention is not limited to the type or nature of rack employed therewith and is intended to accommodate various types of racks or structures that may be used for storage of kitchen goods 44 such as cans, containers, etc. in a kitchen cabinet embodiment. As will be appreciated, the use of sliding rail cars enable the connecting assembly 26 and the associated rack structure 40 to move in a direction parallel to the longitudinal rails. When moved to the outermost position, as depicted in FIG. 4, the rack is pivoted about the connecting assembly or a hinge thereon and over an edge of the horizontal surface, thereby enabling the rack to be reached by a person standing (or sitting) in front of the cabinet. To return the rack 40 to the top of the cabinet, once the goods 44 have been retrieved from or placed on the rack, the user swings the rack upward, as indicated by arrow 94, and slides it back along the rails, as indicated by arrow 96, to store it.

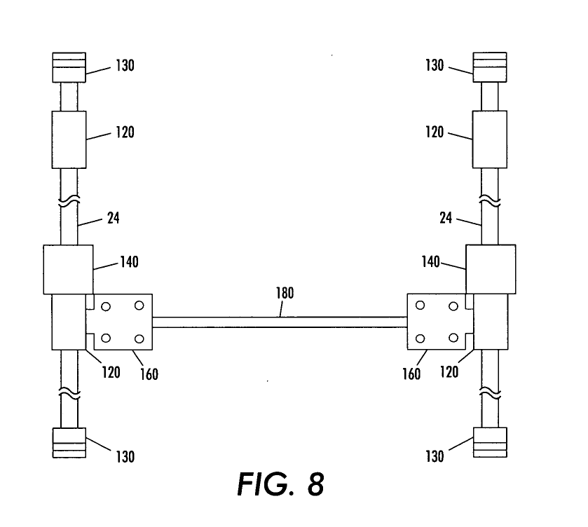

Now, referring to FIGS. 8-12, there are illustrated various parts or components which may comprise further or additional embodiments of the present invention. It will be appreciated that bolts 100 and nuts 110 may be used to operatively connect the various parts of an embodiment, and that alternatives to nuts and bolts may include pins, rivets, straps, clips, and other types of fasteners. Illustrated in FIG. 8 are a rail car 120, end support 130, optional center block 140, accessory bar handle 150, accessory mounting block 160, rail 170, and accessory mounting bar 180.

Also referring to FIGS. 5 and 6, in one embodiment, each rail car comprises a cavity 122 of sufficient size such that longitudinal rail 24 can be positioned in the cavity. In general, the rail car includes in the interior cavity 122 several wheels or rollers that are in contact with the rail top surface or periphery and/or another feature of the rail 24, so that the wheels and/or rollers rotate as the rail car 120 is moved along the rail 24 supported on the wheels.

After the desired number of rail cars 120 have been operatively engaged onto each of the first and second rails 24, an end cap 130 may be positioned over both ends of each rail. The geometry of the end cap cavity 133 is constructed such that the end cap 130 may be attached to longitudinal rails of varying size, shape and dimension. In one embodiment, as shown in the front and side views of FIGS. 11-12, for example, the end cap 130 is operatively connected to the rail 24 by the use of a nut 110 and bolt 100. The end cap 130 may further include a channel 138 located on the top surface of the end cap 130 that is sufficiently sized to hold an accessory mounting bar 180 as well as an optional securing means, for securing the accessory mounting bar in place. The securing means may comprise a pin 135 that is attached to the end cap 130 by cable 137. Pin 135 preferably includes a feature that causes it to remain in place once inserted (e.g., a retaining clip or spring), unless or until it is intentionally removed by a user. It will be appreciated that various alternatives to the pin may be used to secure the accessory mounting bar in place including, locking bolts and other types of fasteners. Another securing means contemplated would include a key-actuated, or tumbler, lock assembly suitable for receiving a key or similar device therein, where a striker bar or similar mechanism actuated by a key in the tumbler moves into or out of position so as to lock the securing means and the mounting bar in place. One example of such a lock mechanism is sold by Thule as theft deterrent lock cores, allowing one key for multiple cylinders (Part No. 512).

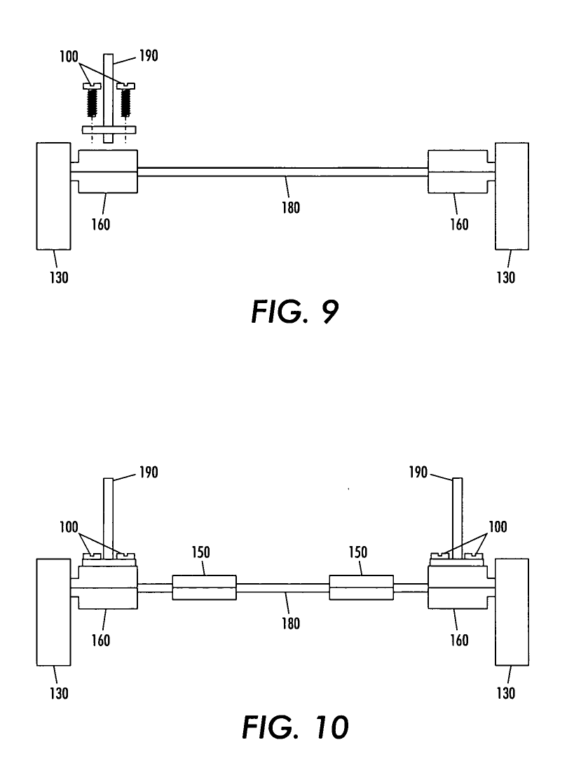

Turning again to FIG. 8, in conjunction with FIG. 9, the two accessory mounting blocks 160 may be located on either end of the accessory mounting bar positioned between a first rail car 120 located on the first rail 24 and a second rail car 120 located directly opposite the first rail car on the second rail 24. The accessory mounting blocks are then operatively connected to the accessory mounting bar 180, to form the connecting assembly 36 and thereby securing the accessory mounting bar in place. Once the accessory mounting blocks are secured, a ski, bike or other type of accessory rack 190 or 40 (FIG. 2) is operatively connected to the accessory mounting block using a nut and bolt or other type of fastener.

Now referring to FIG. 10, in a further embodiment, at least one accessory handle 150 is operatively connected to the accessory mounting bar. The handle may be used to allow the easy lifting and pulling of the accessory mounting bar towards the user.

Having generally described the various embodiments of the present invention, the general operation of the overhead access apparatus will now be set forth. Initially, a user would grasp handle 150 on the accessory mounting bar 180 (or other rack feature). The user would then lift up to remove the mounting accessory 190 (i.e. the ski rack) from the storage/transportation position, and pull the rack in a generally horizontal direction toward the user to bring the rack structure beyond the edge of the vehicle. The user then lowers the end with the handle, causing the accessory mounting bar 180 (or connecting assembly 26) located between the rail cars 30 or 120 to pivot, thereby allowing the handle end to move to a lower height, adjacent to the side of the vehicle. The user then loads the rack (or unloads) and returns it to the storage/transportation position in the reverse of the steps described above.

While this invention has been described with reference to various embodiments as described in detail above, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. An apparatus to enable access to an overhead structure, comprising:
first and second longitudinal rails, said rails being operatively connected to a surface so as maintain the rails in a spaced apart and generally parallel relationship;
at least one rail car supported by and operatively engaged with each of the first and second longitudinal rails; and
a connecting assembly operatively connecting the overhead structure and rail cars to enable said connecting assembly to move in a direction parallel to said longitudinal rails and over an edge of the surface, thereby enabling the overhead structure to be reached by a person below the surface.

2. The apparatus of claim 1, wherein said rail cars include at least two pairs of opposed rollers for contacting an outer peripheral surface of the longitudinal rail to permit the rail car to move along a path determined by the longitudinal rail.

3. The apparatus of claim 2, wherein at least one of said opposed rollers is a bushing-type roller.

4. The apparatus of claim 2, wherein at least one of said opposed rollers is concave along its longitudinal direction.

5. The apparatus of claim 2, wherein at least one of said opposed rollers is flat along its longitudinal direction.

6. The apparatus of claim 2, wherein at least one rail car includes at least five rollers for contacting an outer peripheral surface of the longitudinal rail to permit the rail car to move along a path determined by the longitudinal rail.

7. The apparatus of claim 1, wherein a general cross-sectional geometry of said longitudinal rail is selected from the group consisting of:
a square;
a rectangle;
a circle;
an ellipse;
a hexagon; and
a channel.

8. The apparatus of claim 2, wherein a plurality of said opposed rollers are removable so as to enable the rail car to be easily installed over the longitudinal rail and then attaching the removable rollers to operatively connect the rail car to the longitudinal rail.

9. The apparatus of claim 8, wherein said rail car is of a universal design such that alternative rollers and mounting locations are provided and where said universal design rail car may be employed with a plurality of rail cross-sections.

10. The apparatus of claim 1, wherein at least one rail car includes an aperture for receiving an end of said connecting assembly.

11. The apparatus of claim 10, wherein the end of said connecting assembly is operatively retained in relation to said rail car by a clamping mechanism associated with said rail car.

12. The apparatus of claim 1, wherein said connecting assembly supports the structure thereon and where said structure is offset from the connecting assembly to allow said structure to pivot thereabout when the rail cars are moved toward an outer end of the respective rails.

13. A vehicle transport apparatus to enable access to an overhead rack, comprising:
first and second longitudinal rails, said rails being operatively connected to the rooftop so as maintain the rails in a spaced apart and generally parallel relationship;
at least one rail car supported by and operatively engaged with each of the first and second longitudinal rails; and
a connecting assembly operatively connecting the rail cars to enable said connecting assembly to move in a direction parallel to said longitudinal rails and to pivot over an edge of the rooftop so as to be generally adjacent a side of the vehicle, thereby enabling the rack to be reached at a position other than the rooftop.

14. The apparatus of claim 13, wherein said rail cars include a plurality of opposed rollers for contacting an outer peripheral surface of the longitudinal rail to permit the rail car to move along a path determined by the longitudinal rail.

15. The apparatus of claim 14, further including:
end blocks, operatively connected at an outer end of the respective rails; and
an accessory mounting bar, attached to an outward edge of the rack,
said end blocks being suitable for receiving the accessory mounting bar therein to enable storage of the rack in a fixed position during transport.

16. The apparatus of claim 15, further including a locking mechanism operatively associated with at least one of said end blocks to lock the rack to the rails.

17. The apparatus of claim 14, wherein a plurality of said opposed rollers are removable, said removable rollers enabling the rail car to be easily installed over the longitudinal rail and then attaching the removable rollers to operatively connect the rail car to the longitudinal rail.

18. The apparatus of claim 17, wherein said rail car is of a universal design such that alternative rollers and mounting locations are provided and where said universal design rail car may be employed with a plurality of rail cross-sections.

19. The apparatus of claim 13, wherein at least one rail car includes an aperture for receiving an end of said connecting assembly.

20. The apparatus of claim 19, wherein the end of said connecting assembly is operatively retained in relation to said rail car by a clamping mechanism associated with said rail car.
